(19) United States
(12) Patent Application Publication
(10) Pub. No.: US 2008/0149047 A1
(43) Pub. Date: Jun. 26, 2008

(54) Shot-blasted steam boiler members, steam boiler assemblies or power station components

(76) Inventors: Martin Becker, Leverkusen (DE); Friedrich Klauke, Ratingen (DE)

Correspondence Address: COLLARD & ROE, P.C., 1077 NORTHERN BOULEVARD, ROSLYN, NY, 11576, US

(21) Appl. No.: 12/004,612

(22) Filed: Dec. 21, 2007

(30) Foreign Application Priority Data
Dec. 22, 2006 (DE) 10 2006 062 348.7

(51) Int. Cl. F22B 37/04; B32B 33/00; B24C 1/10; C22C 38/18; C21D 7/06

(52) U.S. Cl. 122/4 R; 428/687; 72/53; 451/38

(57) ABSTRACT

A steam boiler module or steam boiler assembly or a power station component is composed essentially of an alloyed, in particular chromium-containing material and consists, at least in part of a material which has been treated by surface blasting (shot-peening/shot blasting). With steam boilers having outlet temperatures of ≧700° C. in power station components, in particular steam generator modules, the material provides an adequate strength, in particular long-term rupture strength and an adequate corrosion resistance as well as oxidation resistance. The material has a ferritic or martensitic or austenitic structure having a mean chromium content ≦18% by weight, and at least a module surface or module group surface or component surface that has been treated, at least in part, by surface blasting (shot-peening/shot blasting).

### CROSS REFERENCE TO RELATED APPLICATIONS

Applicants claim priority under 35 U.S.C. §119 of German Application No. 10 2006 062 348.7 filed on Dec. 22, 2006.

### BACKGROUND OF THE INVENTION

The invention relates to a steam boiler member or a steam boiler assembly or a power station component, composed essentially of an alloyed, in particular chromium-containing material and being at least partially, in particular predominantly, treated by surface blasting (shot-peening/shot-blasting). In addition, the invention relates to a process for the manufacture of a steam boiler member or assembly or power station component, composed essentially of an alloyed, in particular chromium-containing material in which a surface of the module or group of modules or a component surface, in particular a pipe inner surface, is treated by surface blasting (shot-peening/shot-blasting).

Steam boiler members or power station components are exposed to the oxidising conditions of steam, in particular on the steam side of steam generators of power plant installations, when coming into contact with the steam. Super heater and/or intermediate super heater stages of steam boilers are accordingly nowadays already partially, or even essentially, manufactured of austenitic materials, in particular austenitic steels having a chromium content of 18% by weight, the austenitic material in order to improve the oxidative properties of such materials being treated by surface blasting (shot-peening/shot-blasting). Materials so treated are employed, in particular, in Japanese power stations where steam temperatures of about 600° C. prevail.

During surface blasting or in shot-peening/shot-blasting processes the surface impacted by the treatment particles or blasting particles or blasting material, in the case of pipe lines normally the interior surface of the respective pipe, suffers deformation, whereby a migration, i.e. the diffusion, of chromium from the basic material, i.e. the matrix, towards the treated surface is facilitated and takes place. As a result, there is formed on the treated surface a thin, chromium-enriched layer which counteracts the growth of epitactic and topotactic layers. During surface blasting (shot-peening/shot-blasting) material of the same nature is blasted against the surface to be treated. This promotes the diffusion of chromium from the matrix of the basic material into this layer and thereby the oxidation resistance of this layer.

In the case of the austenitic steels used to date in the super heater and the intermediate super heater region and having a mean chromium content of ≧18% by weight the shot-peening or shot-blasting process brings about a deformation of the treated interior pipe surface of the respective material texture down to a depth of 100 μm, resulting in the formation of a corresponding chromium-enriched layer. Chromium diffuses from the interior of the matrix structure into this treated layer and enriches the latter with chromium. On this chromium-enriched layer the growth of spinel and magnetite layers under the conditions prevailing in the respective power plant components is distinctly slower as compared with untreated surfaces and, accordingly, on the steam side with which these surfaces are connected, the oxidation properties of the material employed and treated are improved.

In power plant construction there is, accordingly, now a tendency to construct power plants which are operated at steam temperatures exceeding 600° C. and even ≧700° C. At such high steam temperatures the problems of oxidation on the steam side of power plant components or steam boiler members becomes the primary subject of considerations. In particular, the problem arises there also that the chromium-containing steels hitherto employed have a martensitic or, in the case of surface-blasting treated chromium contents ≧18% by weight, an austenitic matrix and at the steam temperatures to be expected in the operation of power stations of this new generation are no longer sufficiently oxidation-resistant or are subject to an extremely expensive material consumption.

### SUMMARY OF THE INVENTION

Accordingly, it is the object of the invention to provide a solution by which materials are made available which in the case of steam generators with outlet temperatures of ≧700° C. in power plant components, in particular steam boiler members, have an adequate strength, in particular long-term rupture strength and an adequate corrosion resistance as well as oxidation resistance.

In this context, the invention starts from the concept that it is possible in steam boilers of power plant installations of the new generation, which will have outlet temperatures exceeding 600° C., in particular ≧700° C., to employ steels or steel materials which are clearly reduced in their chromium-content, as compared with steel qualities used to date, in those situations where surface regions, exposed to oxidising conditions, more particularly, since this primarily concerns the interior surfaces of pipe lines, the inner surfaces of the corresponding pipes or tubular bodies, are treated by surface blasting (shot-peening/shot-blasting) and are then installed in the power plant installation, in particular the steam generator. Thereby it becomes possible to employ steel qualities which, on the one hand, are relatively cost-effective, and, on the other hand, also have adequate strength or appropriate strength properties as well as the required oxidation, but also corrosion resistance as required for these high temperatures now arising. The required oxidation resistance now required at such temperatures can be attained in that the side in contact with water, liquid or steam—the steam side—of the respective member or the respective assembly or the respective power plant component, in particular the inner surface of tubular bodies, is treated by means of surface blasting (shot-peening/shot-blasting). As a result of this, the chromium present now becomes enriched in the matrix of the respective material, in particular the steel material, more particularly by the formation of a Cr₂O₃ layer on the treated (exterior) surface of the material. Experience has shown that by means of the surface blasting process (shot-peening/shot-blasting) chromium enrichment by about 50% is possible in the respective treated layer. Accordingly, it is possible by the process according to the invention, to provide, for example, steel qualities having an average chromium content of 9% by weight with an exterior layer on the material, as a rule on the inner surface of a pipe, which—after the treatment—exhibits an average chromium content of about 12% by weight and is, accordingly, rendered adequately oxidation-resistant, even under the conditions of the new power station generations at steam outlet temperatures of ≧700° C.

Surprisingly, contrary to what the person skilled in the art would otherwise have expected, it was found that this improvement of the oxidation performance or the attainment of an adequate oxidation resistance on the steam side is not linked to a simultaneous deterioration of the high temperature corrosion properties of the respective treated steam boiler member or assembly or the respective power station component on the flue gas side. The application of the surface blasting or shot-peening/shot-blasting applied to steel materials of low chromium content, i.e. steels having a chromium content of ≦18% by weight, was actually counter-indicated due to the general fear of persons skilled in the art that the application of this process would lead to an unfavourable chromium distribution in the treated material. The chromium becoming enriched on the steam side or the treated layer in the form of chromium oxides is diffused into this layer from the basic matrix, i.e. the body of the material. Since no chromium is introduced to the material from the outside, the consequences of this diffusion are that this chromium or these chromium particles are now no longer present in other localities of the material. Accordingly, it was to be feared that as a result of this, on the side of the component opposite to the treated side, that is to say in the case of a pipe, on the outside of the pipe, a reduced chromium content might arise. Since with power station components the outside of such pipes is exposed to the corrosive and aggressive conditions of flue gas streams flowing along these, these must have adequate corrosion performance, i.e. an adequate corrosion resistance. For that purpose, the surfaces exposed to flue gas must likewise possess a certain chromium content. Should the chromium content in these surfaces be reduced, this would cause a reduction of the corrosion resistance of the module. Accordingly, there existed a fear that when treating the interior surfaces of the pipe by way of surface blasting (shot-peening/shot-blasting) it might be possible to attain an increased or adequate oxidation resistance, but that, on the other hand, on the outer surface opposite thereto a reduced or deteriorated corrosion resistance might arise.

Furthermore, there existed a fear that because of the uneven distribution of the chromium content brought about, the welding properties of the material on its outer and inner surfaces, respectively its non surface blasting treated and its surface blasting treated sides would have different performance from which, when welding these components, difficulties could be expected.

Although these problems with steel qualities having a chromium content of ≧18′ by weight are of lesser significance, because in view of the relatively high chromium content an adequate amount of chromium is present in order to ensure, also in problematic situations, the required oxidation resistance on the steam side and corrosion resistance on the flue gas side, persons skilled in the art had fears that with weakly alloyed steels, i.e. steels having a clearly reduced chromium content, this might no longer be assured. In particular, in this context the aspect is significant that as a further requirement, the adequate long-term rupture resistance of the material must likewise be warranted.

In particular, the high temperature corrosion resistance, that is to say the corrosion resistance on the flue gas side of a steam generator with chromium contents below 18% by weight exhibits an exponentially progressing deterioration. However, tests have shown that the material reduction represented by a weight loss in terms of mg/cm² and, accordingly, the reduction of the corrosion resistance of the material with chromium contents below 20% by weight, more specifically below 18% by weight, increases very considerably. In particular, the high temperature corrosion at rising temperature, i.e. increasing material temperature, increases such that the high temperature corrosion resistance, in particular in the case of power plants of the next generation, which are to operate at distinctly higher steam outlet temperatures, must have particular regard to this problem. Expedients which might cause a reduction of the high temperature corrosion resistance of a material are, accordingly, not considered to be realistically realisable.

Surprisingly, however, it has now been found that the process according to the invention results in an adequate oxidation resistance of the modules/module groups/components, without causing deterioration of the corrosion resistance.

Surprisingly, it was found in this context that, in particular, materials having a ferritic matrix with a mean chromium content of ≦8% by weight or a martensitic matrix having a mean chromium content of ≦14% by weight, in particular in the range of 9-12% by weight or an austenitic matrix having a mean chromium content of ≦18% by weight can be employed for use as steam generator module or steam generator group of modules or power station component, even when exposed to the conditions as arise at outlet temperatures of ≧600° C., in particular ≧700° C., respectively that such matrices can be selected for the said surface blasting.

In particular, this mode of employment becomes possible if the respective modules or surfaces are treated by surface blasting with a material of the same type or structure and/or material properties or with a material having a higher chromium content than the construction material, as is provided for in a modification of the invention.

By means of the invention it is possible to equip steam boilers having high steam parameters, in particular steam generators with steam outlet temperatures of ≧700° C. with steam boiler members or assemblies or power station components which are adequately temperature-stable and, moreover, are also adequately corrosion-resistant and adequately oxidation-resistant. In particular, by virtue of the invention, steels are also usable having ferritic or martensitic or austenitic structures, which do not have a high chromium content. For example, martensitic steels of the material designation T91/P91 or T92/P92 or also austenitic steels, such as, for example, X3CrNiMoBN17-13-3 (construction material no. 1.4910), are suitable steels which, due to the surface blasting treatment, besides having strength, also exhibit the required corrosion resistance and oxidation resistance in relation to atmospheres and environments as prevail in steam generators with outlet temperatures of ≧700° C. From these materials a vast variety of steam generator modules and power station components can be manufactured, such as membrane walls, spiral-wound steam generator walls, connecting ducts, steam separators and water bottles, injection coolers, heating surfaces, collectors and distributors, support pipe baffles, support pipes, connecting pieces etc. In particular, high-duty collector and pipe ducts as well as membrane walls of the new 700° C. power stations with steam outlet temperatures of ≧700° C. can be produced by means of the steam generator modules according to the invention. As in the case of steels hitherto employed at lower steam outlet temperatures, the use of the shot-peening or shot-blasting process or surface blasting has the result that the growth of a spinel- or magnetite layer on the correspondingly treated surface, i.e. on the surface, which due to surface blasting has been subjected to cold hardening and surface plastic deformation and which, as a result of the treatment, compared with the original material structure, has an increased chromium content as compared with the untreated surfaces, has slowed down quite considerably. Accordingly, it is merely necessary to select for this power station type of the newer generation correspondingly high temperature-resistant steels which subsequently, due to the treatment by means of surface blasting or shot-peening/shot-blasting on the steam-exposed surface, are rendered appropriately oxidation-resistant.

Martensitic steels having a mean chromium content of 9-12% by weight and austenitic steels having a chromium content of ≦18% by weight have been found/identified as a particularly suitable starting material. The denotations ferritic or martensitic or austenitic apply to the respectively prevailing material matrix.

The surface blasting or shot-peening or shot-peening/shot-blasting is particularly performed under such conditions or, respectively, such conditions are set up that the treated module surface or module group surface or power station component surface is or are modifiable to a material depth of 200 μm, preferably up to 100 μm in their structure and/or is/are so influenced. Within the range of this layer thickness of up to 200 μm or up to 100 μm the desired chromium enrichment is developed. In this context, the hardness increase due to the thinness of the layer of this matrix volume exposed to surface blasting in relation to the wall thickness of the respective module or the respective module group or the respective material component with this lower layer thickness, is insignificant so that the strength of the treated module or the treated module group or power station component remains essentially unchanged. The normally predominating, hardness-increasing effect of shot blasting plays no role whatsoever when performing the surface blasting (shot-peening/shot-blasting) according to the invention; and it is, moreover, not intended to play any role. Solely significant is the possibility afforded by the application of this process to so influence the outer layer or an outer layer region of the respective work piece or component (for example, an inner pipe surface), that an enrichment with chromium in this region takes place.

The conditions of surface blasting or shot-peening/shot-blasting are so adjusted in this context that in the surface treated, respectively the treated layer a hardness increase in the range of +50-+150 HV, in particular of about +100 HV based on the original hardness of the material/starting material is set up. In this context the surface blasting is not only performed with a material of a type equal to or having a structure or composition equal to the treated material or with a material of higher chromium content than the starting material, but it is also possible to employ ceramic blasting materials, glass beads or the like. In particular, however, the starting material of the same type or having the same texture or the same composition is used. For this purpose, for example, a wire of the identical material is chopped up, optionally with its ends being rounded and then blasted by means of a fluid jet onto the work piece surface to be treated.

The surface blasting or shot-peening/shot-blasting is performed conventionally with a blasting tube having at its far end a 360° blasting nozzle, so that through the tube blasting material can be fed and then be passed through the blasting nozzle against the inner surface of tubes, respectively the particular tube to be treated. In this case a volume flow of up to 9 m³/min and a maximum blasting pressure of 0.7 MPa are employed. In doing so, the blasting nozzle is passed through the pipe to be treated at a nozzle advance rate of 100-800 mm/min. The “shot-blasting”-effect resides in that on the treated side of the material a layer is formed which is cold-deformed by the shot-blasting or surface blasting. Below this cold-deformed layer there exists a diffusion zone in the matrix of the starting material. From the diffusion zone chromium diffuses through the cold-deformed layer and forms on the outside, i.e. above the cold-deformed layer an oxide layer, in particular a Cr₂O₃-layer above which subsequently under operating conditions the topotactic and the epitactic layer is formed. However, due to the Cr₂O₃-layer the Fe-diffusion is reduced and the growth of magnetite is reduced.

What is claimed is:

1. A device comprising at least a part of a steam boiler member or steam boiler assembly or power station component, the device having the following characteristics:
a. consisting at least partially of an alloyed material having a ferritic or martensitic or austenitic structure;
b. having a mean chromium content ≦18% by weight; and
c. having a surface at least partially treated by means of surface blasting or shot-peening.

2. A device according to claim 1, wherein the device is treated by surface blasting or shot-peening with a material of the same kind or same structure or same composition as the material of the device, or a material which has a higher chromium content than the material of the device.

3. A device according to claim 1, wherein the device is installed on a steam side of a steam boiler having a steam outlet temperature of ≧600° C.

4. A device according to claim 1, wherein the device comprises at least part of an apparatus selected from the group consisting of a heating surface, a membrane wall, a spiral wound steam generator wall, a connecting duct, a: steam separator, a water bottle, an injection cooler, a heating surface, a collector, a distributor, a supporting tube baffle, a supporting tube, a connecting piece and a steam boiler of a power plant.

5. A device according to claim 1, wherein the material is a ferritic or a martensitic or austenitic steel.

6. A device according to claim 1, wherein the material has a mean chromium content of ≦14% by weight.

7. A device according to claim 1, wherein the material has a ferritic structure having a mean chromium content of ≦8% by weight or a martensitic structure having a mean chromium content of ≦14% by weight, or an austenitic matrix having a mean chromium content of ≦18% by weight.

8. A device according to claim 1, wherein the material is a martensitic material selected from the group consisting of T91, P91, T92 and P92, or is a steel X3CrNiMoBN17-13-3.

9. A device according to claim 1, wherein a matrix structure of the surface is affected down to a material depth of 200 μm by the surface blasting or shot-peening.

10. A device according to claim 1, wherein the surface treated with surface blasting or shot-peening has a hardness increase of +50-+150 HV as compared with the surface prior to treatment.

11. A device according to claim 1, wherein the surface treated with surface blasting or shot-peening has the same strength as the surface prior to treatment.

12. A device according to claim 1, wherein the surface treated with surface blasting or shot-peening is an inner surface of a pipe.

13. A process for the manufacture of device consisting of a steam boiler module or steam boiler assembly or power station component, the device being composed essentially of an alloyed chromium-containing material, the method comprising treating a surface of the device by surface blasting or shot-peening, wherein the surface consists of a material having a ferritic, martensitic or austenitic structure, and wherein the material has a mean chromium content of ≦18 percent by weight.

14. A process according to claim 13, wherein the surface blasting or shot-peening is performed with a material of the same kind or same structure or is the same composition as the surface material, or is performed with a material having a chromium content that higher than the chromium content of the surface material.

15. A process according to claim 13, wherein the surface has a ferritic structure with a mean chromium content ≦8% by weight or a martensitic structure having a mean chromium content of ≦14% by weight, or an austenitic structure having a mean chromium content of ≦18% by weight.

16. A process according to claim 13, wherein conditions of surface blasting or shot-peening are adjusted so that a hardness of the surface is increased after treatment with surface blasting or shot-peening, as compared with that of the surface prior to surface blasting or shot-peening, by +50-+150 HV.

17. A process according to claim 13, wherein conditions of surface blasting or shot-peening are adjusted so that the structure of the surface is influenced down to a material depth of 200 μm by the surface blasting or shot-peening.
